(19) United States
(12) Patent Application Publication
(10) Pub. No.: US 2024/0216884 A1
(43) Pub. Date: Jul. 4, 2024

(54) AXIAL REFORMER TUBE

(71) Applicant: Paralloy Limited, Billingham (GB)

(72) Inventors: Dominique Flahaut, Billingham (GB); Barry Fisher, Billingham (GB)

(21) Appl. No.: 18/554,400

(22) PCT Filed: Apr. 6, 2022
(86) PCT No.: PCT/GB2022/050866

§ 371 Date: Oct. 6, 2023

(30) Foreign Application Priority Data
Apr. 7, 2021 (GB) 2104924.2

(51) Int. Cl. B01J 8/06; B01J 8/02; F16L 9/00

(52) U.S. Cl. CPC B01J 8/06; B01J 8/025; F16L 9/006; B01J 2208/00938

(57) ABSTRACT

An axial reformer tube, wherein at least part of the inner surface of the tube has a rough portion having an Ra roughness of 12.5 μm to 500 μm, wherein Ra roughness is the arithmetic mean deviation of the surface; wherein the axial reformer tube extends along an axial length and the inner surface of the rough portion comprises a pattern of circumferential grooves.

This application is a U.S. national phase application under 35 U.S.C. § 371 of international application number PCT/GB2022/050866 filed on Apr. 6, 2022, which claims the benefit of GB application number 2104924.2 filed on Apr. 7, 2021. The entire contents of each of international application number PCT/GB2022/050866 and GB application number 2104924.2 are incorporated herein by reference.

### TECHNICAL FIELD

The present disclosure relates to axial reformer tubes, and more particularly, but not exclusively, to axial reformer tubes for steam-methane reforming.

### BACKGROUND

Steam-methane reforming is a widely used process in the production of hydrogen from natural gas. For example, steam and methane are heated to 700° C.-1,000° C. and 3 bar-40 bar, and passed over a nickel catalyst, producing hydrogen, carbon monoxide and some carbon dioxide, in the highly endothermic steam-methane reforming reaction: CH₄+H₂O→CO+3H₂. Through the moderately exothermic water-gas shift reaction, carbon monoxide and water can be reacted on a catalyst to produce carbon dioxide and further hydrogen: CO+H₂O [symbol] CO₂+H₂. Then, the carbon dioxide can be absorbed by pressure-swing absorption, leaving substantially pure hydrogen.

Steam-methane reforming is commonly conducted in axial reformer tubes (also referred to as reformer catalyst tubes or reformer vessels). Axial reformer tubes are also used in other reforming processes, including the manufacture of ammonia and methanol.

In use, reformer tubes for steam-methane reforming are typically vertically orientated within a furnace (refractory lined box). To withstand the pressures and temperatures required for reforming, and to enable high rates of heat transfer through the wall of the tube, from an external heat source, to the gas flowing along the tube, steel alloy axial reformer tubes are commonly used. An exemplary material used in producing axial reformer tubes is H39WM, a heat resisting austenitic stainless steel from Paralloy Limited with 0.4% carbon, 25% chromium, 35% nickel and 1% niobium.

Both to enhance the strength of the axial reformer tubes, and to increase the ratio of internal surface area to volume for heat transfer between the internal surface of the tube and the gas flowing along the tube, axial reformer tubes are commonly long compared with the internal diameter, e.g. 13 m long with an internal diameter of 10 cm.

In use, gases flow generally axially along the axial reformer tube. The steam-methane reforming reaction occurs where the reagent gases pass over the catalyst, which the gas weaves around as it flows along the axial reformer tube. Gas also flows along the inner surface of the tube.

The catalyst typically has a high surface area to volume ratio and is advantageously shaped to provide a relatively low pressure drop for gas flowing through the catalyst bed.

Axial reformer tubes are typically manufactured by spin casting, with the internal surface being formed by a smooth boring, for example providing an Ra roughness (Ra is the arithmetic mean deviation of the surface) of 3.2 μm to 1.6 μm, which may correspond with an Rt roughness (Rt is the range of the collected roughness data points) of 13 μm to 6.3 μm. Boring the inner surface with a smooth finish is conventionally considered desirable to reduce the pressure drop along the tube by reducing resistance to gas flow along the inner surface of the tube, to maximise the yield of reforming gas products.

### SUMMARY

According to the present disclosure, there is provided an axial reformer tube and a reformer system, as set forth in the appended claims.

According to a first aspect, there is provided an axial reformer tube, wherein at least part of the inner surface of the tube has a rough portion having an Ra roughness of 12.5 μm to 500 μm, wherein Ra roughness is the arithmetic mean deviation of the surface; wherein the axial reformer tube extends along an axial length and the inner surface of the rough portion comprises a pattern of grooves, and wherein the deviation of the grooves from the circumference of the inner surface of the tube is up to 10°.

According to a second aspect, there is provided a reformer system comprising an axial reformer tube according to the first aspect.

The inner surface of the rough portion may have an Ra roughness of at least 25 μm. The inner surface of the rough portion may have an Ra roughness of at least 50 μm. The inner surface of the rough portion may have an Ra roughness of at least 100 μm.

The deviation of the grooves from the circumference of the inner surface of the tube may be up to 5°.

The pattern of grooves may be formed as one or more helical grooves.

The side faces of the grooves may be angled relative to a plane perpendicular to the axial length by a side face angle of 0° to 50°. The side faces of the grooves may be angled relative to a plane perpendicular to the axial length by a side face angle of 0° to 30°. The side face angle may be at least 10°. The side face angle may be up to 25°.

The axial lengths of the bottoms of the grooves may be 50% to 200% of the depth of the grooves.

The grooves may be spaced apart by crowns, and the axial length of the crowns may be 50% to 100% of the depth of the grooves.

The grooves may be spaced apart by crowns and sharp edges are formed between crowns and the side faces of the grooves, the sharp edges having an average radius of curvature of up to 20 μm.

The rough portion may extend along the full length of the tube.

The tube may comprise a smooth portion having an Ra roughness of up to 3.2 μm, coupled to the rough portion.

The rough portion may be coupled between two smooth portions.

The tube may have a length of at least 700 mm.

The internal diameter of the tube may be up to 350 mm.

The tube may have a length of at least 700 mm and the internal diameter of the tube may be 95 mm to 280 mm.

The tube may have a length of at least 2 m. The internal diameter of the tube may be 95 mm to 250 mm.

The reformer system may further comprise:

a catalyst bed packed within at least part of the tube;

a heater to heat at least the part of the axial reformer tube;

a pump to pump gases through the catalyst bed; and

a control system to monitor and control operation of the reformer system.

### DESCRIPTION OF THE DRAWINGS

Examples are further described hereinafter with reference to the accompanying drawings.

FIG. 1A shows an axial reformer tube.

FIG. 1B shows a cut-away view of part of the axial reformer tube of FIG. 1A.

FIG. 1C shows a photograph of part of the inside of an axial reformer tube.

FIG. 1D a view of part of the inside of an axial reformer tube.

FIG. 2 shows an exemplary gas flow across the inner surface of the axial reformer tube;

FIG. 3 shows a further axial reformer tube.

FIG. 4 shows a reformer system.

FIGS. 5A and 5B respectively shows the heat transfer coefficient and pressure drop in three axial reformer tubes with different inner surface roughness.

FIG. 6 is a graph of experimental results showing heat transfer rates for different values inner surface roughness.

FIGS. 7A and 7B respectively show simulated plots of gas temperature along a central plane of two different axial gas reformer tubes.

### DETAILED DESCRIPTION

Like reference numerals refer to like elements throughout.

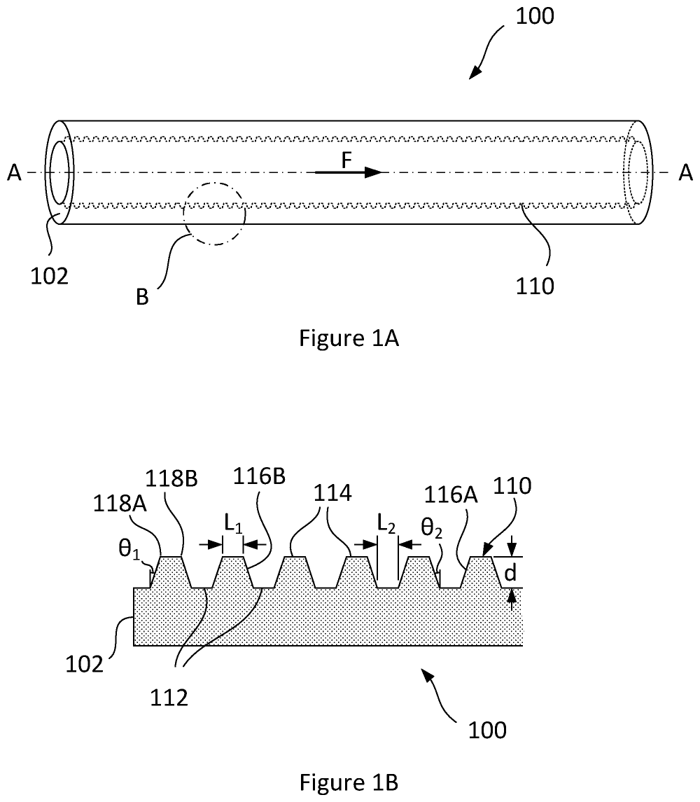

FIG. 1A shows an axial reformer tube 100 for use with a generally axial gas flow F (for purposes of illustration, the catalyst is not shown), and FIG. 1B shows an enlarged view of the region B indicated in FIG. 1A.

The axial reformer tube 100 have an axial length that is much greater than its internal diameter. The axial reformer tube may be hollow cylindrical in shape. In use, subject to passing around the catalyst within the tube, the gas flow F is generally axial, being along the length of the tube 100, indicated by A-A in FIG. 1A.

The inner surface 110 of the tube wall of the axial reformer tube 100 has an Ra roughness of at least 12.5 μm, wherein Ra roughness is the arithmetic mean deviation of the surface (e.g. Rt roughness of at least 50 μm). The roughness of the inner surface of the axial reformer tube alters the flow of gas along the inner surface of the axial reformer tube compared with a smooth inner surface, consequently generating turbulence, which disrupts the formation of a boundary layer and laminar flow along the inner surface of the tube wall. The turbulence enhances the transport of heat from the tube wall to gas flowing through the tube. The provision of the Ra roughness of at least 12.5 μm on the inner surface 110 of the tube wall may enhance heat transport substantially, and Ra roughness of at least 25 μm may enhance heat transport by approximately 10%, with only a small affect upon the pressure drop of gas flowing along the tube. The enhanced rate of heat transfer may enhance the efficiency of the steam-methane reforming reaction. The inventors have identified that the advantage of enhanced heat transfer due to the roughness outweigh the effect of the additional aerodynamic resistance arising from inducing turbulence along the inner surface of the tube wall.

The inner surface 110 of the tube wall has an Ra roughness of up to 500 μm (e.g. Rt roughness of up to 2,000 μm). Limiting the Ra roughness to up to 500 μm promotes mixing of the turbulence generated by the rough surface profile with the flow of gas away from the inner surface, enhancing heat transfer from the tube wall, e.g. rather than turbulence remaining separate, within the depth of the profile (e.g. at the bottom of the grooves 112).

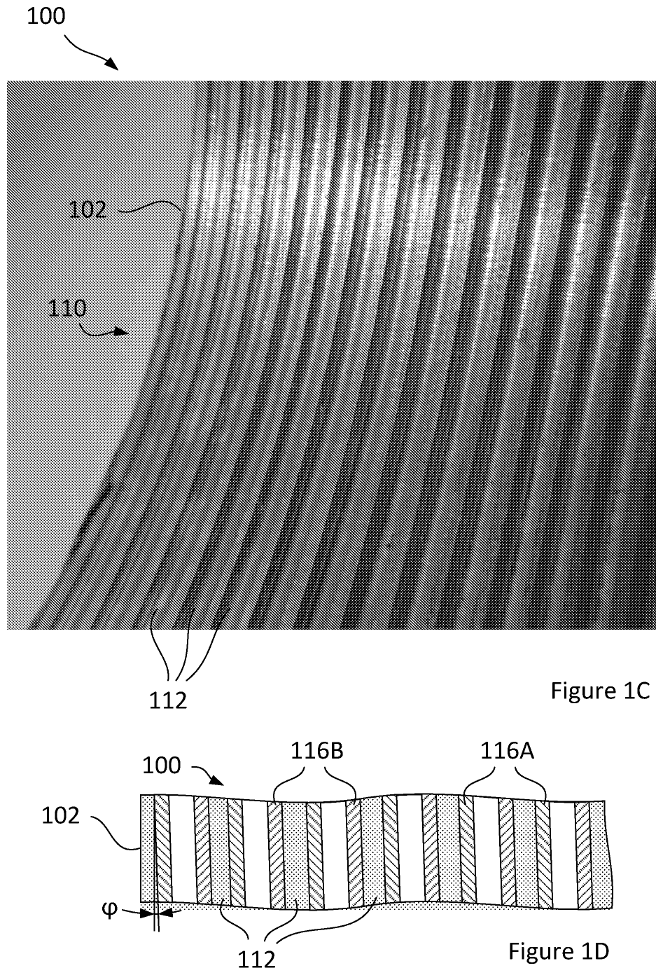

The roughness on the inner surface of the tube wall is formed as a pattern of generally circumferentially extending grooves 112 and ridges 114, as shown in FIGS. 1B, 1C and 1D. FIG. 1D shows a view of the internal surface of part of the axial reformer tube 100, extending from an end 102 of the tube, looking radially outward from the central axis (line A-A in FIG. 1A) of the tube. The grooves 112 may extend around the inner surface with a deviation ϕ from the circumferential direction (perpendicular to the axial direction) of up to 10°, or up to 5°. A low deviation ϕ enhances the formation of turbulent swirls 182 within the grooves 112, shown in FIG. 2, maintaining a gas flow that extends generally perpendicularly across each groove, rather than sweeping the gas out of the groove, hindering the formation of turbulent swirls with the grooves.

For example, the roughness may be provided by one or more helical grooves provided (e.g. cut) into the inner face of the tube 100, as shown in FIG. 1C. Cutting helical grooves provides roughness on the inner surface of the tube 100 with a low manufacturing complexity.

Alternatively, the grooves may extend circumferentially (perpendicular to the axial length of the tube). For example, the grooves may be cut into a flat strip of material (e.g. steel), being cut perpendicularly to the length of a strip, before the strip is rolled across its width, with the edges being sealed (e.g. welded) to form the tube.

FIG. 2 illustrates modelling of gas 180 flowing axially along the axial reformer tube 100, over the inner surface of the tube. Turbulent swirls 182 of gas flow are created in the grooves 112, which enhance the rate at which heat is drawn from the tube wall, compared with a smooth inner surface.

The depth d of the pattern of grooves 112 and ridges 114 is equal to the amplitude of the roughness, and is specified by the Rt roughness, e.g. 50 μm to 2,000 μm (e.g. corresponding with Ra roughness of 12.5 μm to 500 μm). The axial lengths L₁, of the crowns of the ridges 114 may be 50% to 100% of the groove depth d. The axial lengths L₂ of the bottoms of the grooves 112 may be 50% to 200% of the groove depth d. Providing bottoms of the grooves 112 with axial lengths L₂ of 50% and 200% of the groove depth d enhances the formation of turbulent swirls 182 in the grooves. Narrower groove bottoms may limit the size and formation of the turbulent swirls 182 in the grooves 112. Wider groove bottoms may reduce the formation of turbulent swirls 182, by enabling laminar flow to extend into the grooves 112.

The side faces 116A, 116B of the pattern of grooves 112 and ridges 114 generally face towards opposed ends of the tube 100. The side faces 116A, 116B may have perpendiculars that are substantially parallel to the axial length of the tube 100, i.e. side face angles θ₁, θ₂ of substantially 0° (e.g. in the case of the side faces of a helical groove being angled only by the pitch of the helical groove). Alternatively, as shown in FIGS. 1B, 1C and 2, the side face angles θ₁, θ₂ of the side faces 116A, 116B of the pattern of grooves 112 and ridges 114 may be non-zero, each being angled by side face angles θ₁, θ₂ of up to 50° (e.g. up to 30°), providing a thread angle (θ₁+θ₂) of up to 100° (e.g. up to 60°). For example, the side faces 116A, 116B may each be angled by side face angles θ₁, θ₂ of more than 0°, e.g. up to 50° or up to 30°, relative to a plane perpendicular to the length of the tube 100. In FIG. 2, depth d is 200 μm, and the side faces 116A, 116B each have side face angles θ₁, θ₂ of 15°. Angling the side faces by a side face angle θ₁, θ₂ of at least 10° may promote the creation of the turbulent swirl 182 closer to the top of the grooves 112 (i.e. closer to the centre of the tube), rather than deeper into the groove, enhancing the interaction between the turbulent swirl and the adjacent, generally axial gas flow F, enhancing heat transfer from the tube wall and the gas flow F away from the tube wall. Angling the side faces 116A, 116B of the grooves 112 by an angle θ₁, θ₂ of no more than 50° (e.g. no more than 30°) may enhance the creation of a turbulent swirl 182 in the grooves 112, whilst reducing laminar flow through the grooves 112, so enhancing heat transfer from the tube wall to the main flow of gas F.

The edges 118A, 118B of the crowns of the ridges 114 may be sharp. Sharp edges 118A, 118B enhance the formulation of turbulence in gas flowing over them, disrupting laminar flow and creating turbulent swirls 182 in the grooves 112. The sharp edges 118A, 118B may have an average radius of curvature of less than 20 μm.

The roughness of the inner surface 112 of the axial reformer tube 100 also increases the surface area of the inside of the tube 100, compared with a smoothly bored tube, providing a larger surface area from which heat can be transferred to the gas flowing F within the tube, enhancing the rate of heat transfer from the tube wall into the gas flow.

The axial reformer tube 100 in FIG. 1A is shown as a single section with the roughness (e.g. the pattern of grooves and ridges, such as a helical thread) extending along the full length of inner surface of the tube.

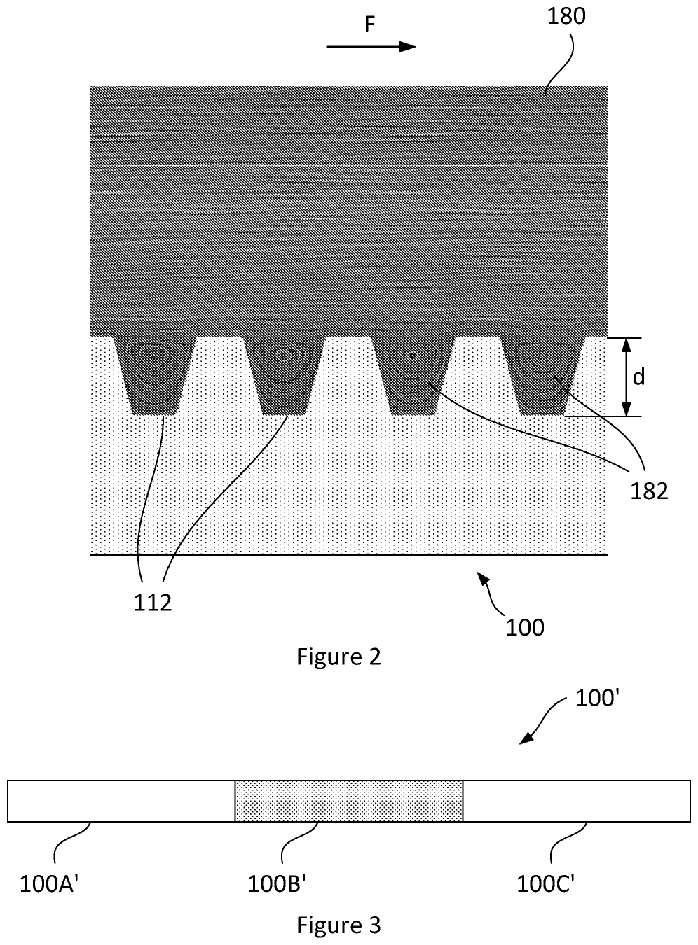

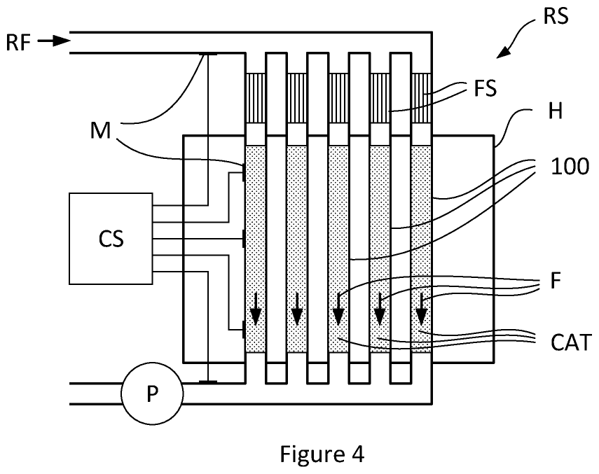

Alternatively, as shown in FIG. 3, a part 100B′ of the tube 100′ (a rough portion) may be formed with the pattern of roughness, and other parts 100A′ and 100C′ of the tube may be formed with a smooth inner surface (a smooth portion). For example, a rough portion 100B′ may be provided between smooth portions 110A′, 110C′, as shown in FIG. 3. Each part may have a length of several meters (e.g. each part may have a length of at least 2 m). For example, the tube may have a rough portion with an inner surface Ra roughness of 12.5 μm to 500 μm, and one or two smooth end portions with a smooth inner surface (Ra roughness of 3.2 μm or less). Roughness may be provided in all, or only part, of the portion of the tube 100 into which the catalyst bed CAT is packed (shown in FIG. 4), to enhance heat transfer from the wall to the gas flowing F through the catalyst and generally along the tube 100′, and a smooth inner surface may be provided in one or more regions from which catalyst is absent, or in regions of the catalyst bed in which enhanced heat transfer is not required. The enhanced heat transfer in the portion of the tube with enhanced roughness may enhance reaction performance. The region of enhanced heat transfer may be aligned with the part of the axial reformer tube in which the most endothermic reaction occurs, e.g. in a particular part of the catalyst bed. The provision of a smooth inner surface in other parts of the tube may reduce aerodynamic resistance to the flow F of gas through the axial reformer tube 100 and reduce manufacturing complexity and related cost.

The axial reformer tubes are many times longer than their internal diameter. The tubes may be several meters long (e.g. the tube may be at least 700 mm long, at least 2 m long, or at least 5 m long; the axial reformer tubes may be 8 m to 13 m long). The tubes may have an internal diameter of much less than a meter (e.g. internal diameter of up to 350 mm, 95 mm to 280 mm, 95 mm to 250 mm, or 95 mm to 175 mm). The axial reformer tube may have a wall thickness of 8 mm to 15 mm.

Commonly the axial reformer tube 100 may be formed by welding together a series of tubular sections, end-to-end. A tube with a part having a rough inner surface and another part having a smooth inner surface may be formed by welding together correspondingly formed tubular sections.

The axial reformer tube 100 may form part of a reformer system RS, in which the tube is provided with a heater, and a bed of catalyst CAT is packed into the tube, as shown in FIG. 4. A plurality of axial reformer tubes 100 may be coupled in parallel to receive a flow RF of reagents. The heater may be a furnace H through which the reformer tubes 100 extend (alternative heaters may be provided, for example ribbon heaters wrapped around each tube). A flow straightener FS may be provided upstream of the catalyst CAT, to reduce turbulence within the flow F of reagents to the catalyst. A control system CS is provided to monitor the flow rates and temperatures of gases in different parts of the reformer system (e.g. monitoring each tube 100, however monitors M are only shown on one tube by way of example), for example before the reagents enter the catalyst, at one or more positions along the length of packed catalyst, and after exiting the catalyst. A pump P is provided to pump the reagents through the catalyst, for example being provided in the downstream flow of product, where the gases are cooler after an endothermic reaction.

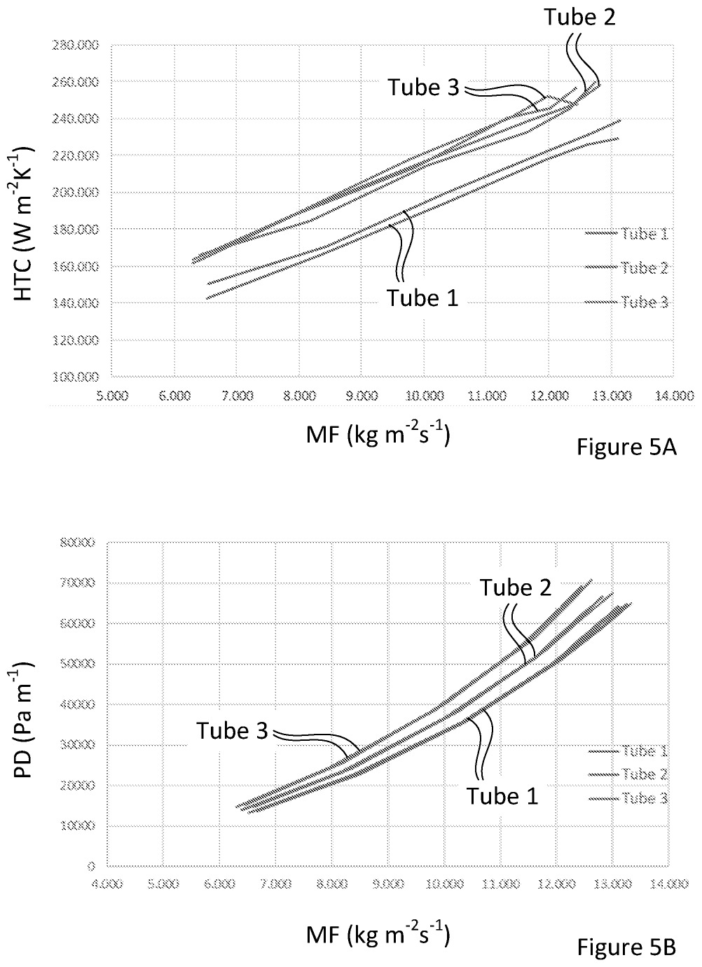

FIGS. 5A and 5B show exemplary experimental data from measuring the heat transfer coefficient of axial reformer tubes 100 with three different values of Ra roughness on their internal surfaces:
Tube 1: inner surface with Ra roughness of 3.2 μm;
Tube 2: inner surface with Ra roughness of 25 μm;
Tube 3: inner surface with Ra roughness of 375 μm.

In the test equipment, air was drawn into an axial reformer tube 100 through a flow straightener FS, and drawn through a packed bed of catalyst CAT (16 mm diameter textured spheres, having a voidage of 0.56) by a pump P. The outside of each axial reformer tube 100 was heated by a ribbon heater wrapped around the tube. Each axial reformer tube was tested twice, collecting corresponding data, as shown.

FIG. 5A shows the heat transfer coefficient of each tube, and FIG. 5B shows the pressure drop in each tube. Tube 1 has a smooth internal surface, and served as a control tube for comparison purposes. The measured heat transfer coefficient of both Tubes 2 and 3 were approximately 10% higher than the heat transfer coefficient of Tube 1.

In Tube 1, the resistance to gas flow F will be lowest next to the inner surface of the axial reformer tube 100. The pressure drop of both Tubes 2 and 3 was also greater than that of Tube 1, corresponding with increased resistance to gas flow next to the inner surface of the axial reformer tube.

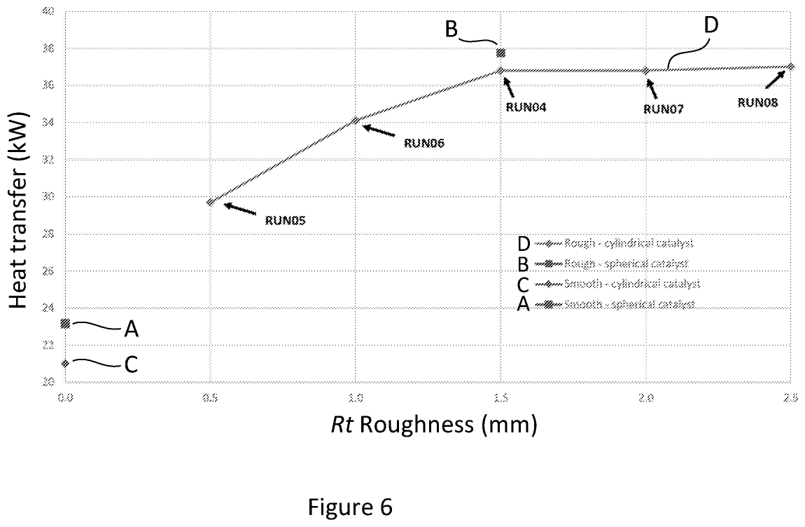

Table 1 shows further exemplary experimental data for measurements of the rate of heat transfer coefficient and pressure drop of axial reformer tubes with different values of Rt roughness, from smooth to 2500 μm (and different values of Ra roughness, e.g. from smooth to approximately 625 μm), in use with a catalyst bed of either spherical or cylindrical catalyst. FIG. 6 shows the heat transfer rates of the protype axial reformer tubes of Table 1.

TABLE 1

| | | | Total | | Total | |
|---|---|---|---|---|---|---|
| | | | pressure | Temperature | heat | Heating |
| | Roughness | Catalyst | drop | increase | transfer | efficiency |
| Test | (Rt) | type | (bar) | (° C.) | (kW) | (° C./bar) |
| 1 | smooth, | spherical | 0.0266 | 43.11 | 23.17 | 1622 |
| | ≤12.5 μm | | | | | |
| 2 | 1500 μm | spherical | 0.0267 | 70.12 | 37.75 | 2627 |
| 3 | smooth, | cylindrical | 0.0203 | 39.21 | 21.01 | 1936 |
| | ≤12. μm | | | | | |
| 4 | 500 μm | cylindrical | 0.0208 | 55.62 | 29.69 | 2671 |
| 5 | 1000 μm | cylindrical | 0.0208 | 63.59 | 34.11 | 3052 |
| 6 | 1500 μm | cylindrical | 0.0208 | 68.79 | 36.81 | 3301 |
| 7 | 2000 μm | cylindrical | 0.0208 | 68.85 | 36.8 | 3318 |
| 8 | 2500 μm | cylindrical | 0.0207 | 69.52 | 37.02 | 3357 |

The rate of heat transfer increases up to an Rt roughness of on the inner surface of the axial reformer tube up to 1500 μm or 2000 μm (e.g. Ra roughness up to approximately 375 μm or 500 μm), with almost no increase in total pressure drop. Above 2000 μm Rt roughness, the increased complexity of manufacturing deeper grooves results in no substantial enhancement of the rate of heat transfer.

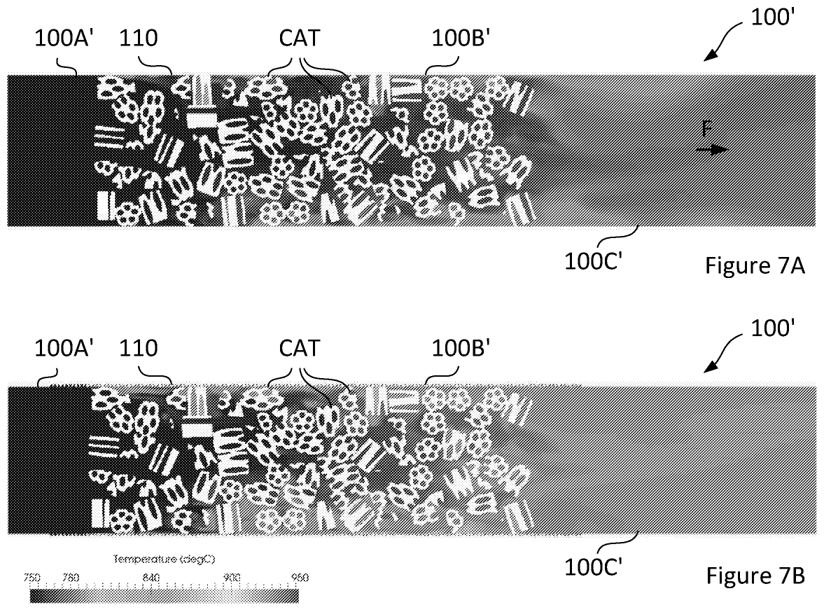

FIGS. 7A and 7B respectively show simulated plots of gas temperature along a central plane of the axial gas reformer tubes with smooth inner surfaces (e.g. Rt roughness ≤25 μm) and 2000 μm Rt roughness (e.g. 500 μm Ra roughness) in use with the same bed of cylindrical catalyst. FIG. 7B shows how the provision of 2000 μm Rt roughness on the portion of the inner surface of the axial reformer tube enhances the rate of heat transfer through the wall of the tube.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An axial reformer tube, wherein at least part of the inner surface of the tube has a rough portion having an Ra roughness of 12.5 μm to 500 μm, wherein Ra roughness is an arithmetic mean deviation of the inner surface,
wherein the axial reformer tube extends along an axial length and the rough portion of the inner surface comprises a pattern of grooves, and
wherein a deviation of the grooves from the circumference of the inner surface of the tube is up to 10°.

2. The axial reformer tube according to claim 1, wherein at least part of the inner surface of the tube in the rough portion has an Ra roughness of at least 25 μm.

3. The axial reformer tube according to claim 1, wherein the deviation of the grooves from the circumference of the inner surface of the tube is up to 5°.

4. The axial reformer tube of claim 1, wherein the pattern of grooves is formed as one or more helical grooves.

5. The axial reformer tube of claim 1, wherein side faces of the grooves are angled relative to a plane perpendicular to the axial length by a side face angle of 0° to 50°.

6. The axial reformer tube of claim 1, wherein side faces of the grooves are angled relative to a plane perpendicular to the axial length by a side face angle of 0° to 30°.

7. The axial reformer tube of claim 5, wherein the side face angle is at least 10°.

8. The axial reformer tube of claim 5, wherein the side face angle is up to 25°.

9. The axial reformer tube of claim 1, wherein each of the grooves has a bottom having an axial length, and wherein the axial length of the bottom of each of the grooves is 50% to 200% of the depth of the grooves.

10. The axial reformer tube of claim 1, wherein the grooves are spaced apart by crowns, each of the crowns having an axial length, and wherein the axial length of each of the crowns is 50% to 100% of the depth of the grooves.

11. The axial reformer tube of claim 1, wherein the grooves are spaced apart by crowns and sharp edges are formed between crowns and side faces of the grooves, the sharp edges having an average radius of curvature of up to 20 μm.

12. The axial reformer tube of claim 1, wherein the rough portion extends along the full axial length of the tube.

13. The axial reformer tube of claim 1, wherein the tube comprises a smooth portion having an Ra roughness of up to 3.2 μm, coupled to the rough portion.

14. The axial reformer tube of claim 13, wherein the rough portion is coupled between two smooth portions.

15. The axial reformer tube of claim 1, wherein the tube has a length of at least 700 mm.

16. The axial reformer tube of claim 1, wherein the internal diameter of the tube is up to 350 mm.

17. The axial reformer tube of claim 1, wherein the tube has a length of at least 2 m and the internal diameter of the tube is 95 mm to 280 mm.

18. The axial reformer tube of claim 1, wherein the tube has a length of at least 2 m and the internal diameter of the tube is 95 mm to 250 mm.

19. A reformer system comprising an axial reformer tube, wherein at least part of the inner surface of the tube has a rough portion having an Ra roughness of 12.5 μm to 500 μm, wherein Ra roughness is an arithmetic mean deviation of the inner surface,
wherein the axial reformer tube extends along an axial length and the rough portion of the inner surface comprises a pattern of grooves, and
wherein a deviation of the grooves from the circumference of the inner surface of the tube is up to 10°.

20. The reformer system of claim 19, further comprising:
a catalyst bed packed within at least part of the tube;
a heater to heat at least the part of the axial reformer tube;
a pump to pump gases through the catalyst bed; and
a control system to monitor and control operation of the reformer system.
